(19) United States
(12) Patent Application Publication
(10) Pub. No.: US 2024/0043686 A1
(43) Pub. Date: Feb. 8, 2024

(54) COLORABLE AND BIODEGRADABLE TRIMMER LINE AND METHOD THEREOF

(71) Applicant: Shakespeare Company LLC, Greer, SC (US)

(72) Inventor: Piyush Dave, Elgin, SC (US)

(21) Appl. No.: 18/361,264

(22) Filed: Jul. 28, 2023

Related U.S. Application Data
(60) Provisional application No. 63/369,820, filed on Jul. 29, 2022.

(51) Int. Cl. C08L 77/02; C08K 5/19; C08K 5/07; C08K 5/101; A01D 34/416

(52) U.S. Cl. CPC C08L 77/02; C08K 5/19; C08K 5/07; C08K 5/101; A01D 34/4168; C08L 2201/06; C08L 2205/025; C08L 2205/03; C08L 2310/00

(57) ABSTRACT

Trimmer lines are provided. The trimmer lines include a nylon majority component, a monomer such as caprolactam, a biodegradation promoter, and a color additive and advantageously having desirable durability, biodegradability, and colorability.

### CROSS-REFERENCE TO RELATED APPLICATION

This application claims priority to U.S. Provisional Patent Application No. 63/369,820, filed Jul. 29, 2022, which is incorporated herein by reference.

### FIELD OF THE DISCLOSURE

This disclosure relates generally to trimmer line and, in particular, relates to high-performance, colorable trimmer line capable of biodegradation.

### BACKGROUND

String trimmer line, also referred to as trimmer line or monofilament, is designed for use in string trimmer machines for cutting or trimming grass, weeds, and other vegetation. The machines are often used to edge around trees, near fences, and along driveways, sidewalks, and walls, as well as along landscape borders. String trimmer machines operate at speeds of up to about 10,000 revolutions per minute (rpm), and the combination of high speeds and the rigidity of the objects against which the trimmer line is impacted results in breakage of the trimmer line during ordinary use.

Trimmer line is typically formed from a polymer such as nylon so that the trimmer line is strong enough to withstand the speeds and impacts common in trimmer line machine usage, but flexible enough to be effective at trimming vegetation. Thus, the breakage of trimmer line that occurs under ordinary use results in small pieces of trimmer line being deposited in the landscape where the string trimmer machine is used. Polymers such as nylon do not readily degrade in the environment, so deposited fragments of broken trimmer line contribute to plastic waste.

Trimmer line is also typically available in a variety of diameters depending on the trimmer machine and the consumer's needs. These diameters are often color-coded so that a consumer may identify the trimmer line size at a glance. However, attempts to improve biodegradability of trimmer line that involve the use of starch necessarily have a brown color that does not easily change with the addition of coloring dyes, forcing manufacturers and consumers to choose between biodegradability and colorability.

One previous attempt at increasing the biodegradability of trimmer line involves the use of petroleum-based polymers with prodegradant catalysts, such as Echo® Oxo-Biodegradable Line from YAMABIKO Corporation, Tokyo, Japan or Bio Trim™ Trimmer Line from B Tool, Inc., Portland, Oregon, USA. The catalysts are responsible for initiating abiotic degradation that disintegrates the trimmer line particles into soil through exposure to oxygen and heat. The resulting particles may then go through biotic degradation. However, photo-oxidative fragmentation still produces micro-plastics, and the unbroken, usable trimmer line must be protected from direct sunlight to prevent premature degradation. Furthermore, any premature burial of the fragmented trimmer line stops the photo-oxidative degradation. Finally, petroleum-based polymeric trimmer line is less durable than nylon trimmer line, even without premature degradation due to sun exposure.

Another previous attempt at increasing biodegradability of trimmer line involves the use of bio-based polymers, such as poly(3-hydroxybutyrate-co-3-hydroxyhexanoate) (PHBH), as seen in Bio-line from Laser Sales Inc., Ontario, Canada, polylactic acid (PLA) polymers, or modified starch-based polymers. However, these bio-based polymers are less durable than nylon, which typically presents as brittleness.

Accordingly, improved trimmer line is needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a graph of percent degradation versus time for trimmer lines formed in accordance with the present disclosure.

FIG. 2 is a graph of percent degradation versus time for trimmer lines formed in accordance with the present disclosure.

FIG. 3 is a plot of L, a, and b values of trimmer lines formed in accordance with the present disclosure.

FIG. 4 is a cross-sectional view of a trimmer line in accordance with the present disclosure.

FIG. 5 is a schematic of a trimmer line in accordance with the present disclosure.

FIG. 6 is a cross-sectional view of a commercial trimmer line.

FIG. 7 is a schematic of a commercial trimmer line.

### DETAILED DESCRIPTION

Trimmer line and trimmer line compositions are provided herein including a nylon polymer or copolymer, a monomer such as caprolactam, a biodegradation promoter, and a color masterbatch. In particular, it has been unexpectedly discovered that incorporating monomers such as caprolactam, caprolactone, 6-aminocaproic acid (6-ACA), adipic acid, hexamethylenediamine, or a mixture thereof into a nylon-based trimmer line composition with a biodegradation promoter produces a synergistic effect that dramatically increases the durability and possibly biodegradability of biodegradable trimmer lines.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Trimmer Line Compositions

Trimmer line compositions are disclosed herein. In some embodiments, the trimmer line compositions comprise a nylon polymer or copolymer, monomers such as caprolactam, caprolactone, 6-aminocaproic acid (6-ACA), adipic acid, hexamethylenediamine, or a mixture thereof, a biodegradation promoter, and a color masterbatch. As used here, a “trimmer line” refers to an extruded monofilament suitable for use in a string trimmer machine. Trimmer line is typically formed by combining precursors in a compounder to form polymeric pellets. These pellets are then melted to form a resin that is extruded through a die having a shape corresponding to the desired cross-sectional shape of the trimmer line.

In some embodiments, the nylon polymer or copolymer or terpolymers includes nylon 6, nylon 66, nylon 610, nylon 611, nylon 612, nylon 613, nylon 614, nylon 615, nylon 618, nylon 12, nylon 6/66, nylon 66/6, nylon 6/69, nylon 6/610, nylon 6/612, mixtures thereof, and/or copolymers thereof.

In some embodiments, the nylon polymer or copolymer is present in an amount of from about 80% to about 99% by weight of the trimmer line composition. In some embodiments, a monomer such as caprolactam, caprolactone, 6-aminocaproic acid (6-ACA), adipic acid, hexamethylenediamine, or a mixture thereof is present in an amount of from about 0% to about 15% by weight of the trimmer line composition. In some embodiments, the biodegradation promoter is present in an amount of from about 0.5% to about 5% by weight of the trimmer line composition.

In some embodiments, the color masterbatch is present in an amount of from about 0.5 to about 2% by weight of the trimmer line composition. It has been unexpectedly discovered that the use of a biodegradation promoter as described herein has minimal effect on the color of the nylon polymer itself, enabling the coloring of the nylon using a color masterbatch. In some embodiments, the color masterbatch includes a color additive present in an amount of from about 10% to about 30% by weight of the color masterbatch.

In some embodiments, the trimmer line composition biodegrades by between 10% to about 27% after 300 days, as measured by ASTM D5511, “Standard Test Method for Determining Anaerobic Biodegradation of Plastic Materials Under High-Solids Anaerobic-Digestion Conditions.” In contrast, conventional 95 mil nylon-based trimmer line degrades no more than about 1% after 660+ days and takes approximately 20,000 years to fully degrade in the environment.

In some embodiments, the trimmer line formed from the trimmer line compositions loses between about 15% and about 20% less material in use as compared to non-biodegradable commercial trimmer line. It has been unexpectedly discovered that incorporating monomers such as caprolactam, caprolactone, 6-aminocaproic acid (6-ACA), adipic acid, hexamethylenediamine, or a mixture thereof into a nylon-based trimmer line composition with a biodegradation promoter produces a synergistic effect that dramatically increases the durability of biodegradable trimmer lines, exceeding even commercial nylon trimmer line without any biodegradability. Without intending to be bound by any particular theory, it is believed that incorporation of monomer or monomers such as caprolactam, caprolactone, 6-aminocaproic acid (6-ACA), adipic acid, hexamethylenediamine, or a mixture thereof and the biodegradation promoter into the nylon polymer forms favorable interfacial interaction in the polymeric matrix, thus increasing the impact toughness and fracture resistance of the trimmer line while imparting biodegradability.

In some embodiments, the biodegradation promoter includes 2-hydroxy-3(trimethylammonio)propyl ether. In some embodiments, the biodegradation promoter includes a monosaccharide, such as an aldohexose. In some embodiments, the biodegradation promoter includes an aliphatic-aromatic ester. In some embodiments, the biodegradation promoter includes a polylactide. In some embodiments, the biodegradation promoter includes BioSphere® 201J Biodegradable Additive pellets, available commercially from BioSphere Plastic LLC, Portland, Oregon, USA. In some embodiments, the biodegradation promoter includes BioSphere® 401 Biodegradable Additive powder, available commercially from BioSphere Plastic LLC, Portland, Oregon, USA. In some embodiments, the biodegradation promoter includes an additive available commercially under the CICLO® brand from Intrinsic Advanced Materials, LLC, Gastonia, North Carolina, USA. In some embodiments, the biodegradation promoter includes an additive available commercially from ECM BioFilms, Inc., Painesville, Ohio, USA, such as ECM 6.0701 Masterbatch pellets.

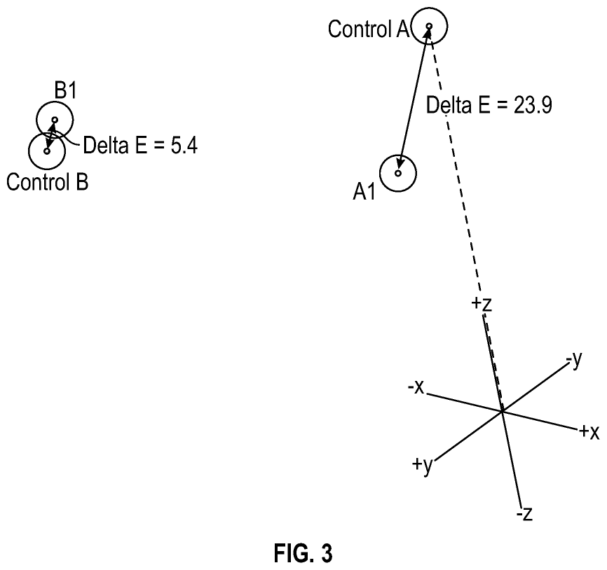

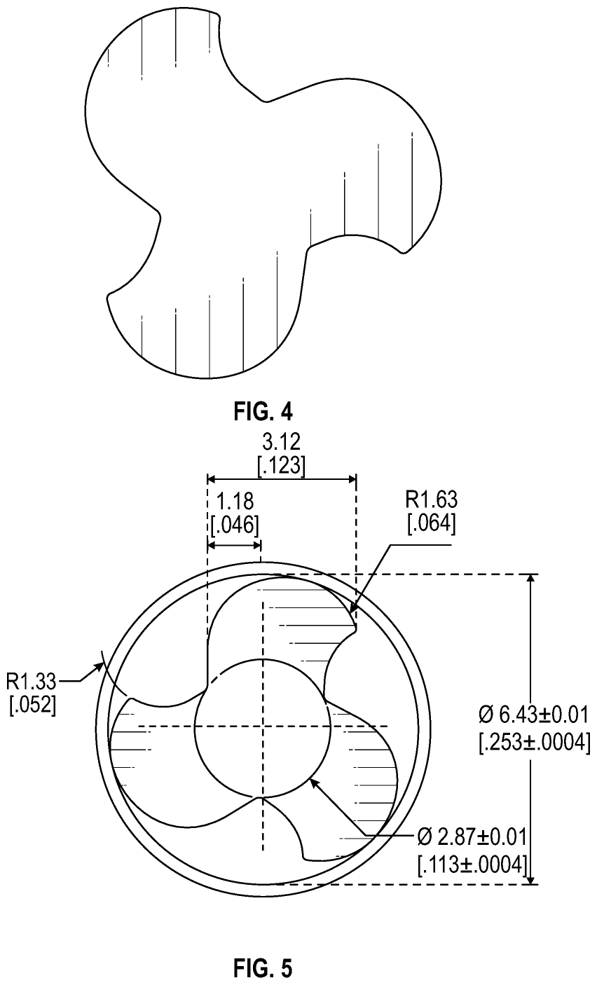

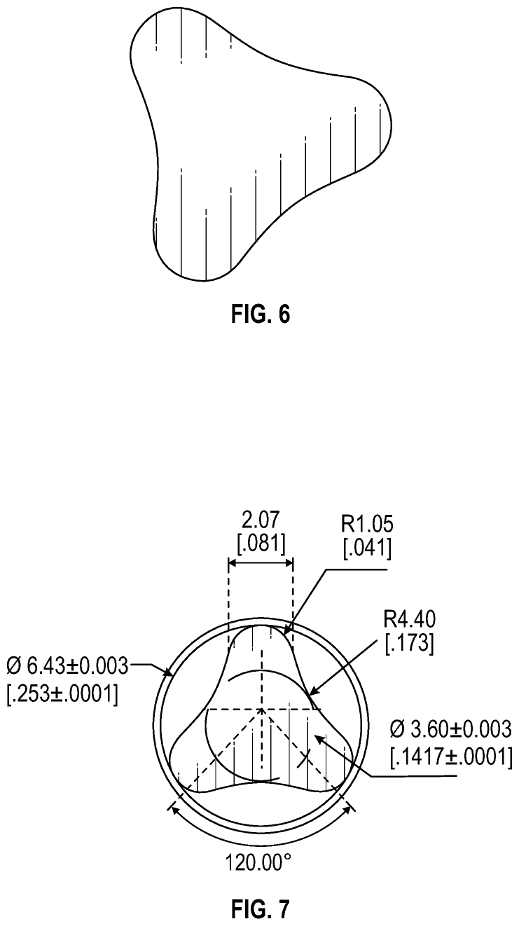

In some embodiments, the trimmer line has a cross-sectional shape having three lobes. In some embodiments, each lobe has an asymmetric profile relative to a radial lobal midline. In some embodiments, each lobe has a first edge having a convex profile and a second edge having a concave profile. It has been unexpectedly discovered that forming a trimmer line to have an asymmetric cross-sectional shape with three lobes with a convex first edge and concave second edge advantageously improves trimmer line performance. For example, a trimmer line having a cross-sectional shape such as the one depicted in FIGS. 3 and 4 has less loss of material than a tri-lobal symmetric cross-sectional shape, such as the one depicted in FIGS. 5 and 6.

In some embodiments, the trimmer line has (i) reduced noise level in operation, (ii) reduced energy consumption by a trimmer machine equipped with the trimmer line, (iii) improved biodegradation, (iv) increased whiteness and/or opacity depending on the amount of biodegradation promoter included, or (v) a combination thereof.

Methods for Producing Trimmer Line

Methods for producing trimmer line are also disclosed herein. In one aspect, the methods include producing trimmer line as described above. In another aspect, the method includes compounding a nylon polymer or copolymer, monomers such as caprolactam, caprolactone, 6-aminocaproic acid (6-ACA), adipic acid, hexamethylenediamine, or a mixture thereof, a biodegradation promoter, and a color masterbatch in a compounder to produce a blend. The method further includes extruding the blend through an extruder to produce the trimmer line.

In another aspect, the method includes adding two or more trimmer line compositions as described herein in a coextrusion process to produce trimmer line with two or more components. In some embodiments, the coextrusion process is through a die suitable to produce a trimmer line having a cross-sectional shape as described herein. In some embodiments, the method includes an embossing treatment imparted to the trimmer line, optionally immediately after extrusion. In some embodiments, the method includes twisting the trimmer line and heat setting the twist, optionally immediately after extrusion, so as to impart a permanent twist. Without intending to be bound by any particular theory, embossing and/or twisting the trimmer line can improve the aerodynamics of the trimmer line in operation, reducing the noise level and/or energy consumption of the trimmers.

### EXAMPLES

The disclosure may be further understood with reference to the following non-limiting examples.

### Example 1: Anaerobic Biodegradation Test

Trimmer line formulations were prepared using polyamide resin and tested in a microbe-rich soil environment. Three primary components were selected for the trimmer line formulations: (1) a high molecular weight polyamide having moisture absorption of at least 1% at saturation; (2) a monomeric molecule configured to improve pliability of the trimmer line, which affects how the trimmer line absorbs and dissipates energy on impact in use and also promote the biodegradation process; and (3) a biodegradability promoter that is melt processable, having a melt point between about 50° C. and 180° C. The biodegradability promoter is a mixture of one or more of aliphatic-aromatic ester, poly(lactic acid), other organoleptic swelling agents, cellulose, starch, dextrose, aldohexose, polar solvents and monomers that are inherently biodegradable, and/or other proprietary biodegradability promoters.

Four trimmer line formulations were prepared as described in Table 1. The biodegradability promoter selected for this test was either BioSphere® 201J Biodegradable Additive pellets (a PLA based bio-active ingredient), available commercially from BioSphere Plastic LLC, Portland, Oregon, USA, or BioSphere® 401 Biodegradable Additive powder (a water soluble bio-active ingredient), available commercially from BioSphere Plastic LLC, Portland, Oregon, USA.

TABLE 1
Trimmer line formulations

| | Formulation | Formulation | Formulation | Formulation |
|---|---|---|---|---|
| Material | A | B | C | D |
| High viscosity Nylon 6, with a | 89% | 88% | 89% | 88% |
| Viscosity number of 256 +/− 12 | | | | |
| ml/g, using ISO 307 method | | | | |
| Caprolactam monomer | 10% | 10% | 10% | 10% |
| BioSphere ® additive (201J | 1% | 2% | — | — |
| pellets) | | | | |
| BioSphere ® additive (401 | — | — | 1% | 2% |
| powder) | | | | |

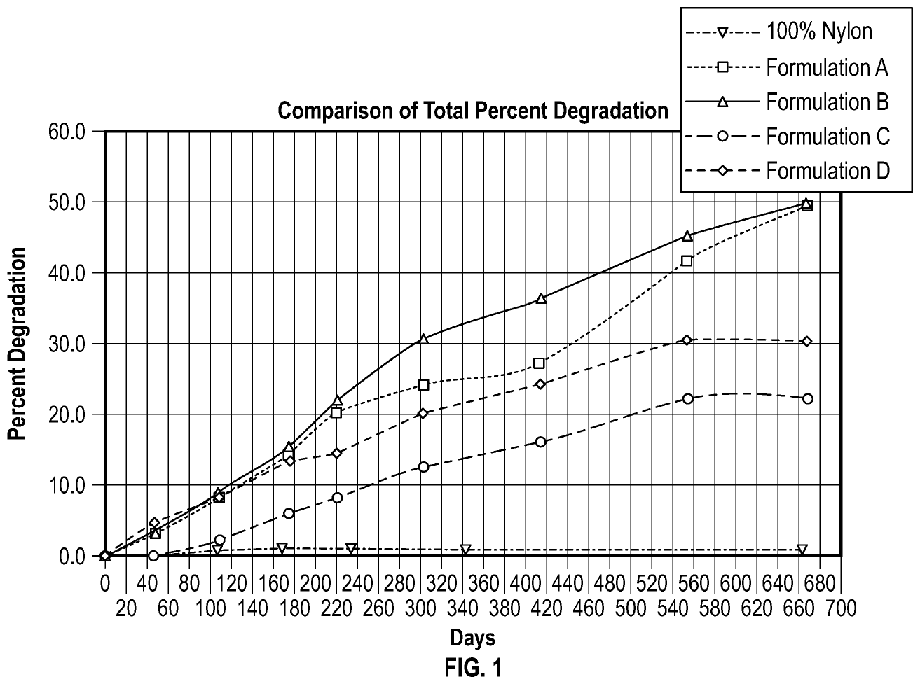

Formulations A-D were tested according to ASTM D5511 and compared to 100% nylon 6. The results are displayed in FIG. 1. As shown in FIG. 1, all four of Formulations A-D exhibited biodegradation. Formulations A and B, which included BioSphere® 201J pellets, each exhibited almost 50% degradation after 666 days. Formulation C exhibited almost 29% degradation after 666 days, while Formulation D exhibited more than 35% degradation after 666 days. In comparison, 100% nylon 6 showed only 1% degradation after 666 days, with no appreciable progression of the degradation process after only 100 days.

### Example 2: Anaerobic Biodegradation Test

Trimmer line formulations were prepared using polyamide resins and tested in a microbe-rich soil environment. Four primary components were selected for the trimmer line formulations: (1) one or more high molecular weight polyamides having moisture absorption of at least 1% at saturation; (2) a monomeric molecule configured to improve pliability of the trimmer line, which affects how the trimmer line absorbs and dissipates energy on impact in use and also promote the biodegradation process; (3) a biodegradability promoter that is melt processable, having a melt point between about 50° C. and 180° C.; and (4) a color additive to impart color to the trimmer line for aesthetic and/or identifying purpose. The biodegradability promoter is a mixture of one or more of aliphatic-aromatic ester, poly(lactic acid), other organoleptic swelling agents, cellulose, starch, dextrose, aldohexose, polar solvents and monomers that are inherently biodegradable, and/or other proprietary biodegradability promoters.

Three trimmer line formulations were prepared as described in Table 2. The biodegradability promoter selected for this test was BioSphere® 201J Biodegradable Additive pellets (a PLA based bio-active ingredient), available commercially from BioSphere Plastic LLC, Portland, Oregon, USA.

TABLE 2
Trimmer line formulations

| | Formulation | Formulation | Formulation |
|---|---|---|---|
| Material | M | N | O |
| High viscosity Nylon 6, with a Viscosity | 98% | 54% | 88% |
| number of 256 +/− 12 ml/g, using ISO 307 | | | |
| method | | | |
| High viscosity copolymer of Nylon 6 and | 0% | 44% | 0% |
| 6,9 with Relative Viscosity of 120 +/− 20, | | | |
| using ASTM D789 method. | | | |
| Caprolactam monomer | 0% | 0% | 10% |
| BioSphere ® additive (201J pellets) | 1% | 1% | 1% |
| Color additive | 1% | 1% | 1% |

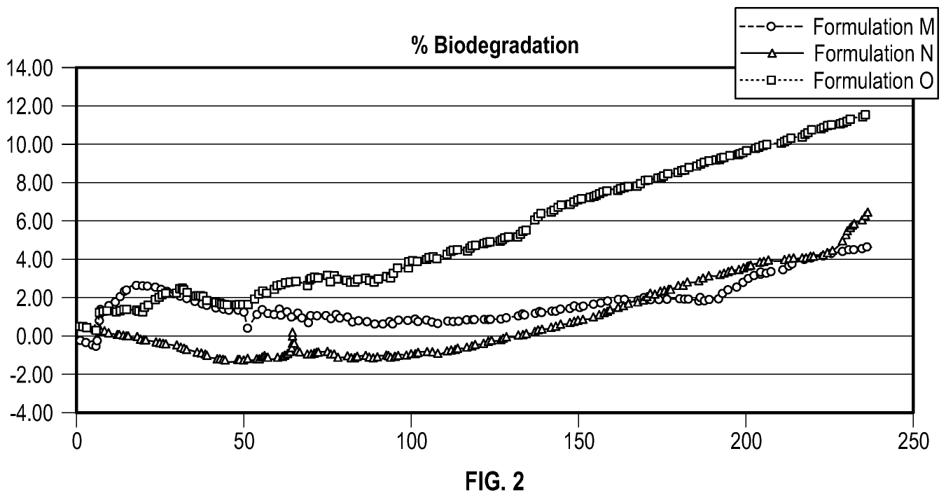

Formulations M-O were tested according to ASTM D5511. The results are displayed in FIG. 2. As shown in FIG. 2, all three of Formulations M-O exhibited biodegradation. Formulations M and N, which included only BioSphere® 201J pellets and no Caprolactam, each exhibited around 5 to 6% degradation after 226 days. Formulation 0 exhibited around 12% degradation after 226 days, indicating the crucial role of monomer, in this case Caprolactam bringing in synergy with the biodegradability promoter such as BioSphere® 201J pellets.

### Example 3: Mass Loss Test

Formulations A, B, and D from Example 1 were tested for mass loss. Two reference samples were tested alongside these formulations: PA6, which is 100% high viscosity nylon 6 with a viscosity number of 256+/−12 ml/g, using ISO 307 method; and NX-747, a proprietary polymeric blend available from Shakespeare Company LLC, Greer, South Carolina, USA. Two commercial samples were tested alongside the reference and inventive samples: Bio Trim™ Trimmer Line from Oregon Tool, Inc., Portland, Oregon, USA; and Bio-line from Laser Sales, Inc., Ontario, Canada.

45 pairs of trimmer line samples were pre-cut to a length of 8.6 inches. Each sample was conditioned at 72-75° F. and 50-55% relative humidity for at least 48 hours. After conditioning, each pair of samples were weighed together and their initial weight, Wo, recorded. Each pair is then loaded into a trimmer head on a trimmer machine. The trimmer machine was fixed in a bracket and the trimmer head is then spun at 10,000 rpm. A medium (metal fence, wood, or brick) is moved at a linear speed of 1.5 inches/sec so that the trimmer line impacts the medium, and then the medium is moved away from the trimmer line. In each test, the medium was moved back and forth twice. The weight of each pair after the test, W n, was then measured. 15 pairs of samples were tested against metal fence, 15 pairs of samples were tested against wood, and 15 pairs of samples were tested against brick. The mass loss percent, average mass of samples in the metal fence tests, average mass of samples in the wood tests, average mass of samples in the brick tests, and overall average percentage of mass retention were calculated based on Formulas 1-5:

$$M ( t ) = \frac{{W}_{0} - {W}_{n}}{{W}_{0}} \times 100 \% \qquad Formula 1$$

$${M}_{f , a v g} = \frac{{M}_{f , 1} + {M}_{f , 2} + … + {M}_{f , 15}}{15} \qquad Formula 2$$

$${M}_{w , avg} = \frac{{M}_{w , 1} + {M}_{w , 2} + … + {M}_{w , 15}}{15} \qquad Formula 3$$

$${M}_{b , avg} = \frac{{M}_{b , 1} + {M}_{b , 2} + … + {M}_{b , 15}}{15} \qquad Formula 4$$

$${M}_{a v g} = \frac{{M}_{f , avg} + {M}_{w , avg} + {M}_{b , avg}}{3} \qquad Formula 5$$

TABLE 3
The results of the mass loss test are displayed in Table 3.
Mass loss test results

| | | | | Overall | |
|---|---|---|---|---|---|
| | Metal Fence | Wood | Brick | Average | % |
| Material | Loss % | Loss % | Loss % | Loss % | Improvement |
| Formulation B | 14.7 | 1.6 | 7.4 | 7.9 | 20.5 |
| Formulation A | 17.5 | 1.3 | 6.1 | 8.3 | 16.3 |
| Formulation D | 17.5 | 0.7 | 7.8 | 8.7 | 12.6 |
| NX-747 | 21.3 | 1.3 | 7.3 | 9.9 | 0.0 |
| (Reference 2) | | | | | |
| PA6 | 21.0 | 1.0 | 9.3 | 10.4 | −4.9 |
| (Reference 1) | | | | | |
| BioTrim from | 14.9 | 10.2 | 21.7 | 15.6 | −56.5 |
| Oregon | | | | | |
| Bio-Line from | 23.4 | 26.4 | 25.6 | 25.1 | −152.7 |
| Laser | | | | | |

As shown in Table 3, Formulations A, B, and D lose less material as compared to the NX-747 commercial trimmer line. 100% nylon performs poorer than the commercial trimmer line, and the commercial biodegradable trimmer lines are significantly more brittle than the commercial trimmer line.

### Example 4: Trimmer Line Color Analysis

Two groups of trimmer line samples were prepared and measured for their L*a*b color space and Delta E measurements, as defined by the Commission Internationale d'Eclairage (International Commission on Light). Group A consisted of a control (Control A) consisting of 100% nylon 6 with no biodegradability promoter, and a biodegradable trimmer line (Sample A1) formed from the same polymer as Control A but with 15-20% starch-based additive. Group B consisted of a control (Control B), which was yellow trimmer line with no biodegradability promoter, and a biodegradable trimmer line (Sample B1) formed from the same polymer as Control B but with 5% BioSphere® 201J pellets.

All samples were measured on a spectrophotometer using a Konica Minolta CR-400 colorimeter, available commercially from Konica Minolta, Inc., Tokyo, Japan. The colorimeter was configured for diffused illumination with a 0° viewing angle and a specular component. The colorimeter was further configured to use illuminant C, which resembled average daylight with a color temperature of 6774K. The observer's field of view was set to 2 degrees.

The L, a, and b values of the samples were recorded, each corresponding to an axis according to the CIE's understanding of opponency in human vision: the L axis represents darkness to lightness, with values ranging from 0 to 100; the a axis represents greenness to redness with values of −128 to +127; and the b axis represents blueness to yellowness also with values from −128 to +127. The ΔE values of the samples were also recorded according to the CIE 1976 method. The results are presented in Table 4 and plotted on a ZXY coordinate of a 3D plotter in FIG. 3.

TABLE 4
L*a*b Color Space and ΔE Measurement Results

| | L value | a value | b value | ΔE from |
|---|---|---|---|---|
| Trimmer line | (Z axis) | (X axis) | (Y axis) | Control |
| Control A | 63.88 | −0.05 | −0.55 | — |
| Sample A1 | 49.36 | 5.46 | 17.12 | 23.9 |
| Control B | 65.9 | −29.62 | 55.95 | — |
| Sample B1 | 70.86 | −27.62 | 54.82 | 5.4 |

As shown in Table 4 and FIG. 3, the ΔE of Sample A1 from Control A was nearly 5 times greater than the ΔE of Sample B1 from Control B, demonstrating the influence of starch on the color of the trimmer line. In contrast, the ΔE of Sample B1 is low, demonstrating that the biodegradability promoter has a low or negligible effect on the color of the trimmer line. With a low ΔE, the trimmer line is capable of accurately taking on the color of a coloring dye.

### Example 5: Trimmer Line Cross-Sectional Shape Analysis

Trimmer lines were formed as described herein having a 0.095 inch diameter. A first trimmer line was formed from high viscosity 100% PA6 (with a viscosity number of 256+/−12 ml/g, using ISO 307 method) nylon having a conventional trilobal cross-sectional shape depicted in FIGS. 6-7. An inventive trimmer line was formed from the same high viscosity 100% PA6 nylon having the inventive trilobal asymmetrical cross-sectional shape depicted in FIGS. 3-4. Each trimmer line sample was conditioned at 70-75° F. and 95% relative humidity for at least 48 hours. Each trimmer line was tested according to the procedure in Example 3. The results are displayed in Table 5.

TABLE 5
Mass loss test for different cross-sections

| | | | | | Overall | |
|---|---|---|---|---|---|---|
| Sample | Cross- | Metal Fence | Wood | Brick | Average | % |
| Composition | section | Loss % | Loss % | Loss % | Loss % | Improvement |
| PA6 (100%) | Tri-lobal | 21.5 | 1.7 | 19.1 | 14.1 | 0.0 |
| PA6 (100%) | Inventive | 19.5 | 2.0 | 14.8 | 12.1 | 14.1 |

In another test, five trimmer line samples were prepared having 0.095 inch diameter. The five samples had varying amounts of (1) high viscosity PA6 nylon (with a viscosity number of 256+/−12 ml/g, using ISO 307 method), (2) caprolactam (capro), and (3) BioSphere® 201J biodegradability promoter. Each sample was conditioned in a lab at 70-75° F. at 50-55% relative humidity for at least 48 hours. Each trimmer line was tested according to the procedure in Example 3. The compositions and results are displayed in Table 6.

TABLE 6
Mass loss test for different cross-sections and compositions

| Sample | Cross- | % Wt Loss | % Wt Loss | % Wt Loss | Average | % |
|---|---|---|---|---|---|---|
| Composition | section | on Chain | on Wood | on Brick | % loss | Improvement |
| PA6 (89%) + | Inventive | 10.6 | 3.4 | 8.6 | 7.5 | 20.7 |
| Capro(10%) + | | | | | | |
| 201J (1%) | | | | | | |
| PA6 (90%) + | Tri-lobal | 11.4 | 3.2 | 8.7 | 7.8 | 17.8 |
| Capro(10%) | | | | | | |
| PA6 (89%) + | Tri-lobal | 12.8 | 1.8 | 9.4 | 8.0 | 15.5 |
| Capro(10%) + | | | | | | |
| 201J (1%) | | | | | | |
| PA6 (100%) | Tri-lobal | 14.8 | 3.2 | 10.3 | 9.4 | 0.0 |
| PA6 (99%) + | Tri-lobal | 24.7 | 1.8 | 10.2 | 12.2 | −29.5 |
| 201J (1%) | | | | | | |

As shown in Table 6, the combination of caprolactam and biodegradation promoter in a nylon-based trimmer line having a cross-sectional shape as depicted in FIGS. 4-5 produces the strongest trimmer line.

Thus, it has been unexpectedly discovered that incorporating a biodegradation promoter and monomer such as caprolactam into a trimmer line formulation increases biodegradability, increases strength, and reduces material loss in use as compared to non-biodegradable or other commercial biodegradable formulations, while retaining the ability for the trimmer line to be colored according to consumer interests.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A trimmer line composition comprising:
a nylon polymer or copolymer,
a monomer comprising caprolactam, caprolactone, 6-aminocaproic acid (6-ACA), adipic acid, hexamethylenediamine, or a mixture thereof,
a biodegradation promoter, and
a color masterbatch.

2. The trimmer line composition of claim 1, wherein the nylon polymer or copolymer or terpolymers comprises nylon 6, nylon 66, nylon 610, nylon 611, nylon 612, nylon 613, nylon 614, nylon 615, nylon 618, nylon 12, nylon 6/66, nylon 66/6, nylon 6/69, nylon 6/610, nylon 6/612 mixtures thereof, and/or copolymers thereof.

3. The trimmer line composition of claim 1, wherein the nylon polymer or copolymer is present in an amount of from about 80% to about 99% by weight of the trimmer line.

4. The trimmer line composition of claim 1, wherein the monomer is present in an amount of from about 0% to about 15% by weight of the trimmer line.

5. The trimmer line composition of claim 1, wherein the biodegradation promoter is present in an amount of from about 0.5% to about 5% by weight of the trimmer line.

6. The trimmer line composition of claim 1, wherein the color masterbatch is present in an amount of from about 0.5% to about 2% by weight of the trimmer line composition.

7. The trimmer line composition of claim 6, wherein the color masterbatch comprises a color additive present in an amount of from about 10% to about 30% by weight of the color masterbatch.

8. The trimmer line composition of claim 1, wherein the trimmer line biodegrades by between 22% to about 50% after 666 days as measured by ASTM D5511.

9. The trimmer line composition of claim 1, wherein the trimmer line loses between about 15% and about 20% less material in use as compared to non-biodegradable commercial trimmer line.

10. The trimmer line composition of claim 1, wherein the biodegradation promoter comprises 2-hydroxy-3-(trimethylammonio)propyl ether.

11. The trimmer line composition of claim 1, wherein the biodegradation promoter comprises a monosaccharide.

12. The trimmer line composition of claim 11, wherein the monosaccharide comprises an aldohexose.

13. The trimmer line composition of claim 1, wherein the biodegradation promoter comprises an aliphatic-aromatic ester.

14. The trimmer line composition of claim 1, wherein the biodegradation promoter comprises a polylactide.

15. A trimmer line comprising the trimmer line composition of claim 1.

16. The trimmer line of claim 15, wherein the trimmer line has a cross-sectional shape comprising:
three lobes, wherein each lobe has an asymmetric profile relative to a radial lobal midline, and wherein each lobe has a first edge having a convex profile and a second edge having a concave profile.

17. The trimmer line of claim 15, wherein the trimmer line has been embossed.

18. The trimmer line of claim 15, wherein the trimmer line has been twisted.

19. A method for producing trimmer line comprising:
compounding (i) a nylon polymer, copolymer, terpolymer, or mixture thereof, (ii) caprolactam, caprolactone, 6-aminocaproic acid (6-ACA), adipic acid, hexamethylenediamine, or a mixture thereof, (iii) a biodegradation promoter, and (iv) a color masterbatch in a compounder to produce a blend; and
extruding the blend through an extruder to produce the trimmer line.
